(19) United States
(12) Patent Application Publication
(10) Pub. No.: US 2004/0099796 A1
(43) Pub. Date: May 27, 2004

(54) Optical input-sensing device

(75) Inventor: Cruise Lee, Taipei (TW)

Correspondence Address: TROXELL LAW OFFICE PLLC, SUITE 1404, 5205 LEESBURG PIKE, FALLS CHURCH, VA, 22041, US

(73) Assignee: Sysgration Ltd.

(21) Appl. No.: 10/304,741

(22) Filed: Nov. 27, 2002

(51) Int. Cl. G06M 7/00

(52) U.S. Cl. 250/221

(57) ABSTRACT

An optical input-sensing device for moving a pointer by optics is disclosed. The optical input-sensing device is composed of an optical sensing chip, a luminous body, a lens and a transparent plate. The luminous body projects light to a light-sensing range of the transparent plate having functions of fixing the imaging distance and assisting focus. Then the optical sensing chip gets the image of the movement of an objective, such as a finger or pen, and converts the movement image into data information so as to get the moving direction for moving the pointer.

### BACKGROUND OF THE INVENTION

1. Field of the Invention

The present invention relates to an optical input-sensing device, and more particularly to a device, in place of the touchpad or trackball on the notebook and keyboard, for operating the computer or moving the cursor by setting a transparent plate in the light-sensing range. The device uses a luminous body to project light in the sensing range, and adds a transparent plate in the sensing range to facilitate fixing the imaging position. A lens of the device focuses and transmits the image in the sensing range to an optical sensing chip to facilitate getting the image and further processing into data by the optical sensing chip so as to get the moving direction and subject.

2. Description of the Prior Art

The notebook of the prior art mostly uses the trackball or touchpad to facilitate operating the computer by the user. The operations of the two input devices are affected by palmar hyperhidrosis. Therefore, most users operate the computer by an external mouse in supplement. In addition, a common optical mouse uses optical technology to project the light to a refractor by an LED diode. Then the light is reflected to a sensing range by the refractor. By the reflective objective on the table, the optical sensing chip can receive the image for moving the cursor. However, the application of the optical input-sensing device according to the prior art is usually limited to the location that causes inconvenience and troubles, since it must rely on a platform for providing the input of sliding sensation.

Therefore, the device of the prior art has many defects when used in some location. So it is not a good design and should be improved.

Because of the above described disadvantages generated from the input-sensing device of the prior art, the applicant keeps on carving unflaggingly to develop the optical input-sensing device of the present invention through wholehearted experience and research.

### SUMMARY OF THE INVENTION

It is an object of the present invention to provide an optical input-sensing device applied to a notebook, PDA or keyboard, and the operator can operate the screen cursor only by moving the finger or pen.

It is another object of the present invention to provide an optical input-sensing device applied to a meeting brief for pointing, and the operator can operate the pointer only by holding the present device and moving his fingers.

It is an additional object of the present invention to provide an optical input-sensing device in which a transparent plate and a lens are added in the sensing range for assisting focus, and the cursor can be moved by moving an objective having light-reflection nature, such as a finger or pen, on the transparent plate.

The optical input-sensing device which can achieve the above-mentioned objectives, includes:

a luminous body for projecting light to a lens by its illuminating function;

an optical sensing chip having the functions of getting image and analysis;

a sensing range for projecting light of a lens therein;

a lens for projecting the image in the sensing range to the sensing chip; and

a transparent plate set in the sensing range on the optical sensing chip for assisting to fix imaging.

The luminous body provides the light for the optical input-sensing device of the present invention. The luminous body can be a diode or light bulb, and projects the light in the sensing range. The transparent plate is added in the sensing range for providing a good imaging distance. In addition, a lens is added for assisting the focus function. When an objective having light-reflection nature, such as a finger or pen, moves on the transparent plate, the optical sensing chip gets the image and further analyzes to calculate the moving direction of the objective.

### BRIEF DESCRIPTION OF THE DRAWINGS

The drawings disclose an illustrative embodiment of the present invention which serves to exemplify the various advantages and objects hereof, and are as follows:

FIG. 1 is a schematic view showing the optical input-sensing device of the present invention;

FIG. 2 is an application view showing the optical input-sensing device of the present invention;

FIG. 3 is an application view showing the optical input-sensing device of the present invention installed in a hand-held remote control;

FIG. 4 is an application view showing the optical input-sensing device of the present invention installed in a PDA; and

FIG. 5 is an application view showing the optical input-sensing device of the present invention installed in a notebook.

### DETAILED DESCRIPTION OF THE PREFERRED EMBODIMENT

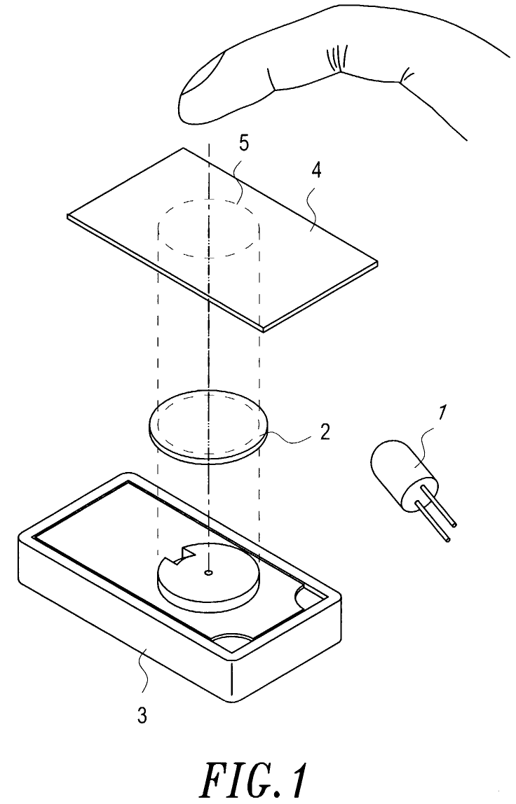

Please refer to FIG. 1 showing the device of the present invention. The present invention provides an optical input-sensing device mainly composed of a luminous body 1, an optical sensing chip 3, a transparent plate 4 and a lens 2, in which a sensing range 5 is for the luminous body 1 to directly project light therein. The transparent plate 4 is set in the sensing range 5 for passing through the light without affecting the sensing ability. The optical sensing chip 3 can get image by the refracted light generated from the moving of an objective in the sensing range 5. Through analyzing the image got by the optical sensing chip 3 into data information, the moving direction is known and the reaction subject can be changed.

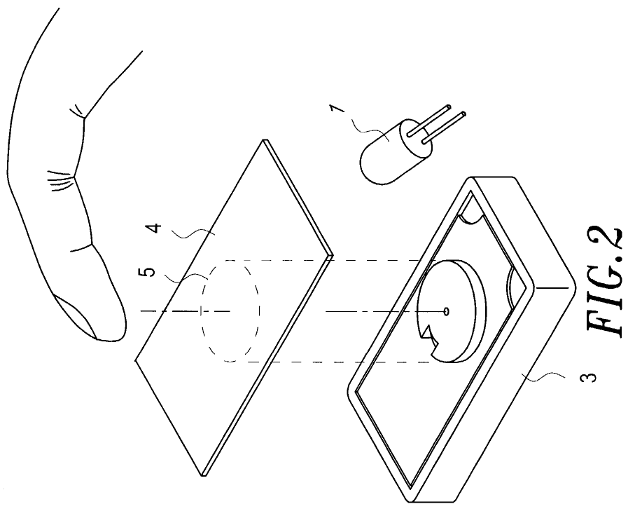

Please refer to FIG. 2 showing the application view. The optical input-sensing device provided by the present invention is mainly operated by fingers or pens, in which the fingers or pens simply move on the transparent plate 4, and the optical sensing chip 3 can get the image therefrom. A lens 2 can be also added to increase the focus function. By converting the image into data information, the moving direction is known.

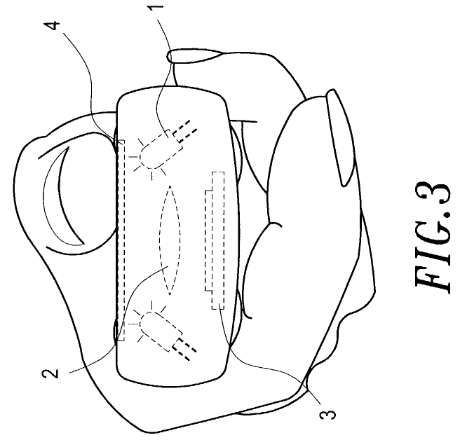

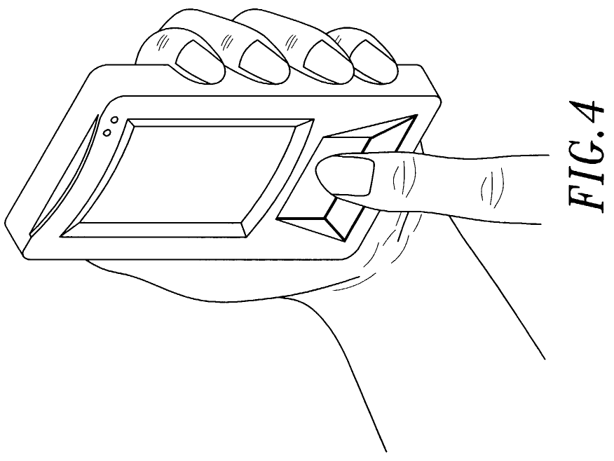

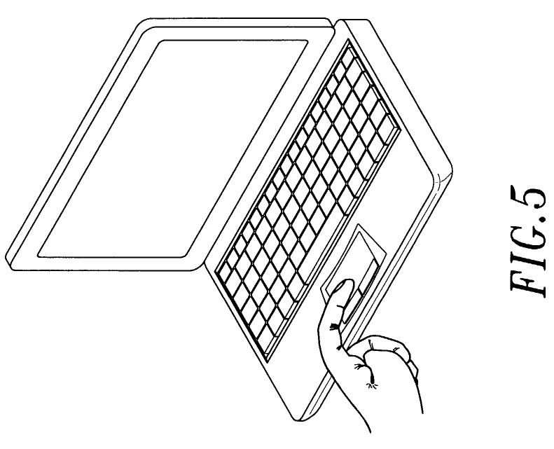

Please refer to FIGS. 3-5 showing the application views. The optical input-sensing device provided by the present invention can be installed in the PDA, notebook, pocket PC and hand-held remote control.

The optical input-sensing device provided by the present invention has the following advantages:

1. It can be used without a platform to support.

2. It is convenient and effort-saving since the device can sense the action through the moving of fingers or refractive objects.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An optical input-sensing device, comprising:
a luminous body for illuminating on a transparent plane;
a transparent plate set in a sensing range to transparently isolate said device and get a good imaging distance;
a sensing range for projecting light of a lens therein;
a lens for projecting an image in said sensing range to a sensing chip; and
an optical sensing chip for getting said image and detecting a movement change by processing said image to get a moving direction;
wherein said optical input-sensing device is composed of said optical sensing chip, said transparent plate, said luminous body and said lens, said luminous body directly projects light in said sensing range of said transparent plate, said sensing range is defined by a projection of said lens, said transparent plate has a function of fixing said imaging distance and focuses a reflection of an objective on said optical sensing chip through said lens, and said optical sensing chip gets said image and said moving direction by converting said image into data information.

2. The optical input-sensing device according to claim 1, wherein said device is installed in a notebook for fingers or other objectives to move thereon so as to move a cursor or an item.

3. The optical input-sensing device according to claim 1, wherein said device is installed in a PDA for fingers or other objectives to move thereon so as to move a cursor or an item.

4. The optical input-sensing device according to claim 1, wherein said device is installed in a pocket PC for fingers or other objectives to move thereon so as to move a cursor or an item.

5. The optical input-sensing device according to claim 1, wherein said device is installed in a keyboard for fingers or other objectives to move thereon so as to move a cursor or an item.

6. The optical input-sensing device according to claim 1, wherein said luminous body is a diode.
